(19) United States
(12) Patent Application Publication
(10) Pub. No.: US 2013/0084479 A1
(43) Pub. Date: Apr. 4, 2013

(54) SECONDARY BATTERY

(71) Applicant: SANYO ELECTRIC CO., LTD., Moriguchi City (JP)

(72) Inventors: Taiki Nonaka, Kakogawa City (JP); Toyoki Fujihara, Kanzaki County (JP)

(73) Assignee: SANYO ELECTRIC CO., LTD., Moriguchi City (JP)

(21) Appl. No.: 13/630,468

(22) Filed: Sep. 28, 2012

(30) Foreign Application Priority Data
Sep. 30, 2011 (JP) 2011-217393

(51) Int. Cl. H01M 4/70; H01M 2/18

(52) U.S. Cl. 429/94

(57) ABSTRACT

A secondary battery with a flat wound electrode assembly includes a positive and negative electrode substrate exposed portions formed on the first and second end thereof, respectively. An end portion of a negative electrode active material mixture layer of a negative electrode plate on the negative electrode substrate exposed portion side protrudes more than an end portion of positive electrode active material mixture layer of an adjacent positive electrode plate. The negative electrode substrate exposed portion is converged on the central site in the thickness direction of the electrode assembly. A separator is located at the outermost surface of the electrode assembly, and the separator and the negative electrode substrate exposed portion of the adjacent negative electrode plate are fixed integrally with a fixing member. Thereby, semi-floating and peeling of the negative electrode active material mixture layer hardly occur at the end side of the negative electrode substrate exposed portion.

### TECHNICAL FIELD

The present invention relates to a secondary battery including a flat wound electrode assembly having higher reliability.

### BACKGROUND ART

Secondary batteries such as lithium ion secondary batteries or nickel-hydrogen secondary batteries are widely used as driving power sources for mobile electronic apparatuses such as contemporary mobile telephones, portable personal computers, and portable music players, or as power sources for hybrid electric vehicles (HEVs, PHEVs) and electric vehicles (EVs). As such secondary batteries, prismatic secondary batteries rather than cylindrical secondary batteries are highly needed in particular when space efficiency is required.

A prismatic secondary battery, in particular, a prismatic nonaqueous electrolyte secondary battery is produced as follows. A negative electrode plate with negative electrode active material mixture layers including a negative electrode active material in both faces of a negative electrode substrate such as a copper foil shaped in an elongated sheet is produced. In addition, a positive electrode plate with positive electrode active material mixture layers including a positive electrode active material in both faces of a positive electrode substrate such as an aluminum foil shaped in an elongated sheet is produced.

Then, the negative electrode plate and the positive electrode plate are stacked with each other and a separator formed of microporous polyethylene film, for example, is interposed therebetween, the stacked negative electrode plate and positive electrode plate are helically wound around a cylindrical core in a manner that the electrode plates are insulated from each other by the separator, thereby producing a cylindrical wound electrode assembly. Next, the cylindrical wound electrode assembly is flattened using a press machine and formed into a flat wound electrode assembly, the resultant is inserted into a prismatic outer body, the mouth portion of the outer body is sealed except an electrolyte pour hole, the electrolyte pour hole is closed after an electrolyte is introduced therethrough, so that a prismatic nonaqueous electrolyte secondary battery is assembled.

As a method for attaching a collector to the flat wound electrode assembly, for example, as disclosed in JP-A-2009-032640, the following sequence is executed: each of a stacked positive electrode substrate exposed portion and a stacked negative electrode substrate exposed portion is converged on the central site in the thickness direction thereof; a positive electrode collector and a negative electrode collector are disposed on both faces of the converged positive electrode substrate exposed portion and negative electrode substrate exposed portion; and the positive electrode substrate exposed portion and the negative electrode substrate exposed portion are resistance-welded to the positive electrode collector and the negative electrode collector, respectively. The method for attaching the collector to the flat wound electrode assembly will be described with reference to FIG. 8. FIG. 8A is a partially enlarged sectional view illustrating a method for attaching a collector to the side of a negative electrode substrate exposed portion of a flat wound electrode assembly disclosed in JP-A-2009-032640. FIG. 8B is a schematic enlarged view of a portion VIIIB of FIG. 8A.

In a flat wound electrode assembly 40, a negative electrode substrate exposed portion 41 is converged on the central site in the thickness direction thereof. A pair of negative electrode collectors 42 and 43 are disposed on both faces of the converged negative electrode substrate exposed portion 41. A pair of resistance welding electrodes 44 and 45 come into contact with the pair of negative electrode collectors 42 and 43 from each side. The negative electrode substrate exposed portion 41 is resistance-welded to the negative electrode collectors 42 and 43 while pressing both resistance welding electrodes 44 and 45.

With the flat wound electrode assembly disclosed in JP-A-2009-032640, since the negative electrode substrate exposed portion 41 and the negative electrode collectors 42 and 43 are resistance-welded rigidly, internal resistance is small and in particular, it is optimum for a prismatic nonaqueous electrolyte secondary battery that is required to have high power and large capacity for an EV, HEV, and PHEV, for example. It is preferable to configure a flat wound electrode assembly used in such a prismatic nonaqueous electrolyte secondary battery so that an end portion of a negative electrode active material mixture layer of a negative electrode plate on the negative electrode substrate exposed portion side protrudes more than an end portion of a positive electrode active material mixture layer of an adjacent positive electrode plate in order to set a charging capacity ratio between the negative electrode plate and the positive electrode plate (negative electrode charging capacity/positive electrode charging capacity) of more than 1.

In order to provide a prismatic nonaqueous electrolyte secondary battery with high power and large capacity in a flat wound electrode assembly 40 as disclosed in JP-A-2009-032640, increasing the number of windings of an electrode plate and the thickness of active material mixture layers in each electrode plate causes the following problem. As shown in FIG. 8B, a negative electrode substrate exposed portion 41a located in a region of the outermost surface of the negative electrode plate 46 is considerably bent at a side edge portion of a positive electrode active material mixture layer 47a of the positive electrode plate 47 as a fulcrum when converging on the central site in the thickness direction thereof. For this reason, a negative electrode active material mixture layer 46a located outside of the region of the outermost surface of the negative electrode plate 46 can be semi-floated from the negative electrode substrate and cause peeling at the side edge of the negative electrode substrate exposed portion 41a. Reference numeral 49 in FIG. 8B denotes a separator. As a result of analyses, it was found that, in the vicinities of boundary regions between the straight portions and the curved portions of the outer surface of the flat wound electrode assembly 40 (near the curve section), in other words, in the cross section orthogonal to the winding axis of the flat wound electrode assembly 40, semi-floating and peeling of the negative electrode active material mixture layer 46a tend to be generated near the boundary regions between the straight portions and the curved portions of the elliptical outer surface.

If the negative electrode active material mixture layer causes semi-floating and peeling at the end side of the negative electrode substrate exposed portion, conductive foreign materials are introduced into the battery since the negative electrode active material is conductive, and reliability of the battery declines.

### SUMMARY

An advantage of some aspects of the invention is to provide a secondary battery including a flat wound electrode assembly in which a separator located at the outermost surface and an adjacent negative electrode substrate exposed portion are fixed, so that the negative electrode active material mixture layer hardly causes semi-floating and peeling at the end side of the negative electrode substrate exposed portion even if the negative electrode substrate exposed portion located in a region of the outermost surface of the negative electrode plate is considerably bent.

An example of a flat wound electrode assembly in which a separator in the outermost surface is fixed with an adhesive tape to prevent short circuit by regulating contraction of the separator caused by temperature rising is illustrated in JP-A-2007-073317. The flat wound electrode assembly disclosed in JP-A-2007-073317 will be described below with reference to FIGS. 9A to 9D. FIG. 9A is an external perspective view of a flat wound electrode assembly disclosed in JP-A-2007-073317. FIG. 9B is a diagram illustrating a winding state of the flat wound electrode assembly depicted in FIG. 9A. FIG. 9C is a sectional view taken along IXC-IXC line of FIG. 9A. FIG. 9D is an external perspective view of a plurality of flat wound electrode assemblies to which collectors are attached.

As disclosed in JP-A-2007-073317, a flat wound electrode assembly 50 includes a positive electrode substrate exposed portion 51 and a negative electrode substrate exposed portion 52 on one side edge portion and another side edge portion, respectively, and with respect to a separator 53 in the outermost surface, a first adhesive tape 55 with heat resistance is attached to an end-of-winding portion 54 of the separator 53 and second adhesive tapes 57 with heat resistance are attached to both side edge portions 56 of the separator 53 while the side edge portions 56 are tensioned along the width direction thereof. As shown in FIG. 9B, the flat wound electrode assembly 50 is produced by flatly winding a positive electrode plate 51a and a negative electrode plate 52a with respective separators 53a and 53 interposed therebetween so that the positive electrode substrate exposed portion 51 and the negative electrode substrate exposed portion 52 are formed on one side edge portion and another side edge portion, respectively. Accordingly, as shown in FIG. 9C, the second adhesive tapes 57 are attached to the separator 53 at the outermost surface, the separator 53a on the inner side, and the positive electrode substrate exposed portion 51 on the positive electrode substrate exposed portion 51 side at the same time. Similarly, the second adhesive tapes 57 are attached to the separator at the outermost surface and the negative electrode substrate exposed portion 52 on the negative electrode substrate exposed portion 52 side at the same time.

In the flat wound electrode assembly 50 disclosed in JP-A-2007-073317, however, as shown in FIG. 9D, positive electrode substrate exposed portions 51, and negative electrode substrate exposed portions 52 of a plurality of flat wound electrode assemblies 50 are connected to a positive electrode collector 58 and a negative electrode collector 59, respectively, without any processing, and thus the above-mentioned problem to be solved by the invention does not occur therein.

According to an aspect of the invention, a secondary battery includes a flat wound electrode assembly including a positive electrode plate with a positive electrode substrate having positive electrode active material mixture layers on both faces and with a positive electrode substrate exposed portion along the longitudinal direction, a negative electrode plate with a negative electrode substrate having negative electrode active material mixture layers on both faces and with a negative electrode substrate exposed portion along the longitudinal direction, and a separator interposed therebetween, the positive electrode plate, the negative electrode plate, and the separator being wound together. The flat wound electrode assembly includes the wound positive electrode substrate exposed portion formed on one end portion thereof and the wound negative electrode substrate exposed portion formed on another end portion thereof. An end portion of a negative electrode active material mixture layer of the negative electrode plate on the negative electrode substrate exposed portion side protrudes more than an end portion of a positive electrode active material mixture layer of the adjacent positive electrode plate. The negative electrode substrate exposed portion is converged on a central site in the thickness direction of the flat wound electrode assembly. The separator is located at the outermost surface of the flat wound electrode assembly. The separator located at the outermost surface and the negative electrode substrate exposed portion of the adjacent negative electrode plate are fixed integrally with a fixing member.

In the secondary battery of the invention, the separator located at the outermost surface and the negative electrode substrate exposed portion of the adjacent negative electrode plate are fixed integrally with the fixing member. As a result, semi-floating and peeling of the negative electrode active material mixture layer hardly occur at the end side of the negative electrode substrate exposed portion even if the negative electrode substrate exposed portion is considerably bent because of convergence of the negative electrode substrate exposed portion on the central site in the thickness direction of the flat wound electrode assembly. For this reason, with the secondary battery of the invention, the conductive foreign materials are hardly introduced into a battery. Accordingly, it is possible to produce a secondary battery having higher reliability.

Examples of a fixing member that can be used in the invention may include a tape with adhesive, an adhesive, and a thermal welding resin. In view of easiness of fixing, a tape with adhesive is preferable. It should be noted that typical separators used in nonaqueous electrolyte secondary batteries are contracted by heat. Thus, fine temperature control is required when a thermal welding resin is used. In the case where a tape with adhesive is used, examples of a resin that can be used for a tape may include a film of plastic such as polyethylene (PE), polypropylene (PP), polyethylene-terephthalate (PET), polyimide, polyphenylene sulfide (PPS), acrylic resin, acrylonitrile-butadiene-styrene (ABS) resin, nylon, polystyrene, polyurethane, polyvinyl chloride, polyamide, and polycarbonate, woven fabric, non-woven fabric, and silicon. Examples of an adhesive for a tape may include an acrylic resin adhesive, a urethane resin adhesive, an epoxy resin adhesive, a silicon-based adhesive, a styrene-butadiene rubber adhesive, a nitrile rubber-based adhesive, a phenol resin adhesive, and a polyimide-based adhesive. It is desirable to select appropriate material taking account its reactivity with electrolyte.

The invention does not include flat wound electrode assemblies in which only a negative electrode substrate is wound at the outermost surface or a negative electrode plate with a single face to which a negative electrode active material is applied only at the outermost surface because the problems to be solved by the invention do not occur in these cases. In the case of a flat wound electrode assembly in which, at the outermost surface, there is no separator and a negative electrode active material mixture layer is exposed, semi-floating and peeling of the negative electrode active material mixture layer rarely occurs if the negative electrode active material mixture layer and the negative electrode substrate exposed portion are fixed by using a tape with adhesive at the outermost surface. The invention does not include the case described above. A negative electrode active material mixture layer exposed at the outermost surface will be subjected to the subsequent processes to the winding and can result in less reliability of a battery because pieces of the negative electrode active material mixture layer may stick to the periphery and become contamination.

In the secondary battery of the invention, it is preferable that the negative electrode substrate exposed portion be equally converged on the central site in the thickness direction of the flat wound electrode assembly.

In the invention, the phrase “converged on the central site in the thickness direction” means that, in the thickness direction of the flat wound electrode assembly, the converged substrate exposed portion are equally converged on the central site so that the distances from the outermost surface are nearly equal. When the negative electrode substrate exposed portion is equally converged on the central site in the thickness direction of the flat wound electrode assembly, a stress applied to the outermost surface region of the negative electrode can be reduced and semi-floating and peeling of the negative electrode active material mixture layer can be prevented more certainly with the fixing member served as semi-floating prevention means.

In the second battery of the invention, it is preferable that the fixing member be provided to each of both faces of the flat wound electrode assembly.

semi-floating and peeling of the negative electrode active material mixture layer can occur in both faces of the flat wound electrode assembly. With the configuration described above, however, since the fixing member served as the semi-floating prevention means is provided to each of both faces of the flat wound electrode assembly, semi-floating and peeling of the negative electrode active material mixture layer can be suppressed more favorably.

In the secondary battery of the invention, it is preferable that a collector member be provided to each of both outermost surfaces of the negative electrode substrate exposed portion.

When the collector member is provided to each of both outermost surfaces of the negative electrode substrate exposed portion, a stress applied to the outermost surface region of the negative electrode plate can be more equalized, and semi-floating and peeling of the negative electrode active material mixture layer can be suppressed even more. In addition, a contact area between the negative electrode substrate exposed portion and the collector member can be enlarged. Accordingly, connecting rigidity between the negative electrode substrate exposed portion and the collector member can be increased and variations in resistance of the connecting portion can be reduced. The collector member in the invention includes a collector member directly connected to a terminal and also includes a collector member connected to a terminal via other conductive member or a current breaker. The collector member is also used to mean a collector member, i.e., a collector supporting member directly connected only to the negative electrode substrate exposed portion.

In the secondary battery of the invention, it is preferable that a converged section of the negative electrode substrate exposed portion be divided into two portions, and a conductive intermediate member be disposed between the two portions of the converged section. In this case, a plurality of such conductive intermediate members may be supported by an insulating intermediate member.

In a flat wound electrode assembly with high power and large capacity, the number of layers of the negative electrode substrate exposed portion is increased. With this configuration, the converged section of the negative electrode substrate exposed portion is divided into two portions, the conductive intermediate member is disposed between the two portions of the converged section of the negative electrode substrate exposed portion, so that even if the negative electrode substrate exposed portion at the outermost surface is converged on the central site in the thickness direction of the flat wound electrode assembly, curvature thereof can be reduced compared with the case without any intermediate member. Accordingly, the stress applied to the outermost surface region of the negative electrode plate can be reduced. For this reason, with this configuration, it is possible that semi-floating and peeling of the negative electrode active material mixture layer hardly occur at the end side of the negative electrode substrate exposed portion, even if the flat wound electrode assembly has high power and large capacity.

Using a conductive intermediate member allows welding the collector member disposed on each of both outer faces of the converged section of the negative electrode substrate exposed portion divided into two portions, the bisectional negative electrode substrate exposed portion, and the conductive intermediate member together by series resistance welding at the same time. A component consisting of a conductive member can be used alone as the conductive intermediate member. When a component in which a plurality of conductive intermediate members are supported by insulating intermediate member formed by a resin body or other materials, the conductive intermediate members can be stably disposed in the bisectional converged section. Accordingly, a second battery with less variation in internal resistance can be provided.

In the secondary battery of the invention, it is preferable that an end-of-winding portion of the negative electrode plate be located near a corner of the flat wound electrode assembly, and the fixing member be disposed near three corners of the flat wound electrode assembly except the corner in which the end-of-winding portion is located.

When the end-of-winding portion is located near the corner, semi-floating and peeling of the negative electrode active material mixture layer does not occur at that portion, thus the fixing member is unnecessary. In this case, it is enough that the fixing member is disposed near three corners except the corner in which the end-of-winding portion is located.

### BRIEF DESCRIPTION OF THE DRAWINGS

The invention will be described with reference to the accompanying drawings, wherein like numbers reference like elements.

FIG. 1 is a partial development view illustrating arrangement relation between electrode plates and a separator of a wound electrode assembly of a prismatic nonaqueous electrolyte secondary battery that is under producing.

FIG. 2A is a sectional view of the prismatic nonaqueous electrolyte secondary battery. FIG. 2B is a sectional view taken along IIB-IIB line of FIG. 2A. FIG. 2C is a sectional view taken along IIC-IIC line of FIG. 2A.

FIG. 3A is a perspective view of a flat wound electrode assembly of an embodiment. FIG. 3B is a perspective view of the backside of the flat wound electrode assembly of FIG. 3A. FIG. 3C is a sectional view taken along IIIC-IIIC line of FIG. 3A.

FIG. 4 is a lateral sectional view illustrating a state of resistance welding between a negative electrode substrate exposed portion and a collector.

FIG. 5A is a sectional view taken along IIC-IIC line of FIG. 2A corresponding to Modification Example 1. FIG. 5B is a sectional view taken along IIC-IIC line of FIG. 2A corresponding to Modification Example 2.

FIG. 6A is a perspective view of a flat wound electrode assembly of Modification Example 3. FIG. 6B is a perspective view of the backside of the flat wound electrode assembly of FIG. 6A.

FIG. 7A is a perspective view of a flat wound electrode assembly of Modification Example 4. FIG. 7B is a perspective view of the backside of the flat wound electrode assembly of FIG. 7A.

FIG. 8A is a partially enlarged sectional view illustrating a method for attaching a collector to the side of a negative electrode substrate exposed portion of a flat wound electrode assembly in a conventional example. FIG. 8B is a schematic enlarged view of a portion VIIIB of FIG. 8A.

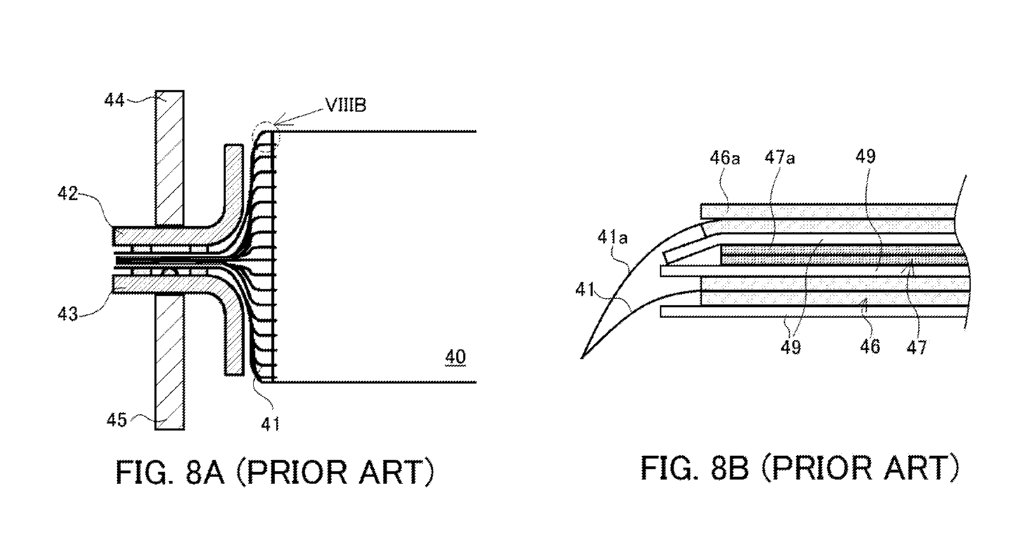

FIG. 9A is an external perspective view of a flat wound electrode assembly in a conventional example. FIG. 9B is a diagram illustrating a winding state of the flat wound electrode assembly depicted in FIG. 9A. FIG. 9C is a sectional view taken along IXC-IXC line of FIG. 9A. FIG. 9D is an external perspective view of a plurality of flat wound electrode assemblies to which collectors are attached.

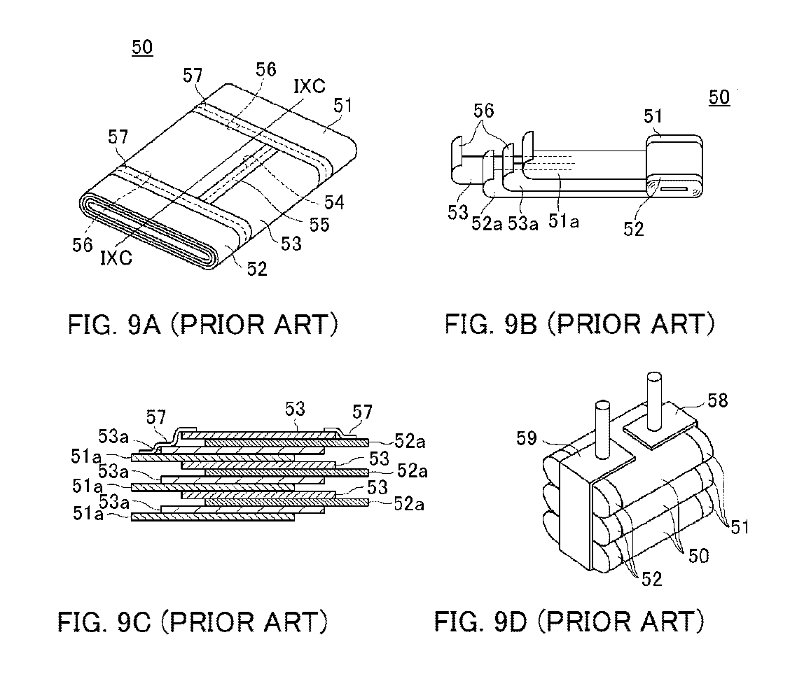

### DESCRIPTION OF EXEMPLARY EMBODIMENTS

An embodiment of the invention will now be described in detail with reference to the drawings. The embodiment below is, however, intended to exemplify the technical spirit of the invention, the invention is not intended to be limited to the embodiment, and the invention may equally be applied to various modified cases without departing from the technical spirit described in the claims. In each drawing used for explanation in the specification, each member is appropriately shown on a different scale so that the member has a recognizable size in each drawing and the members are not necessarily shown in proportion to the actual sizes.

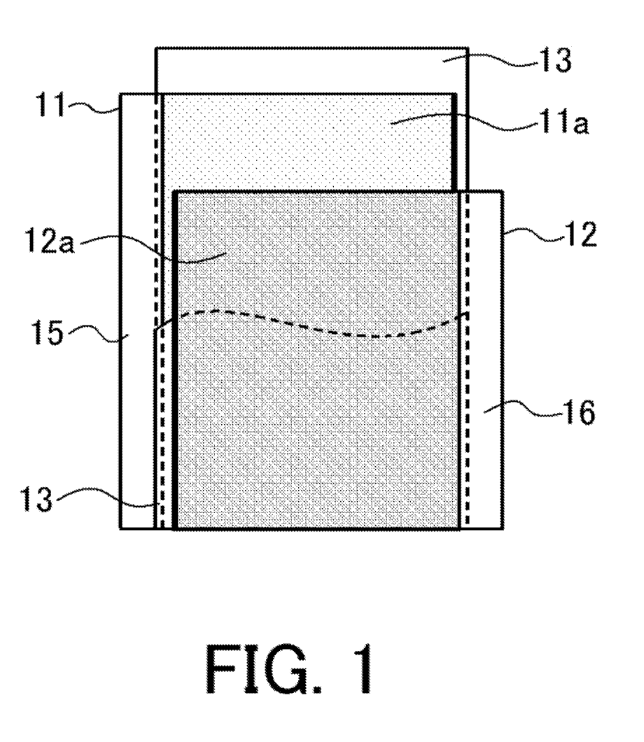

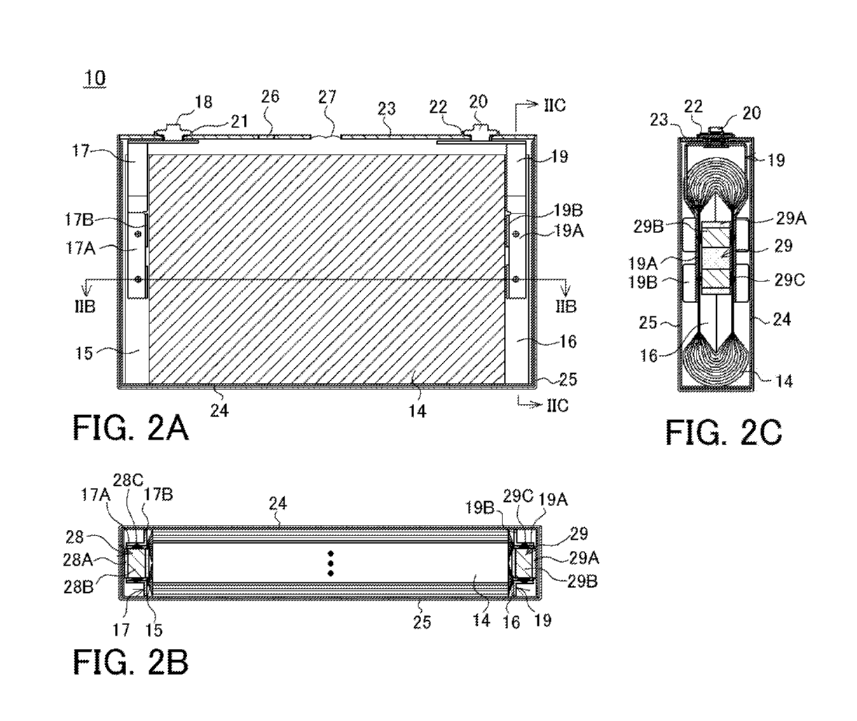

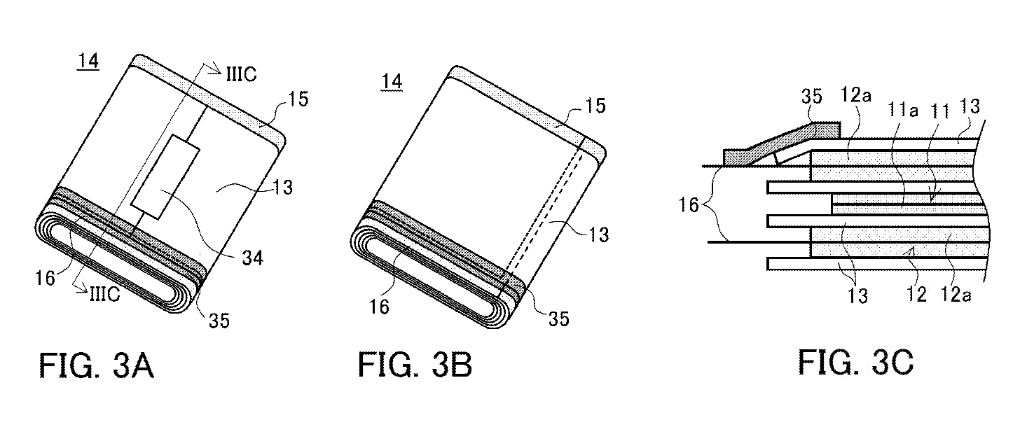

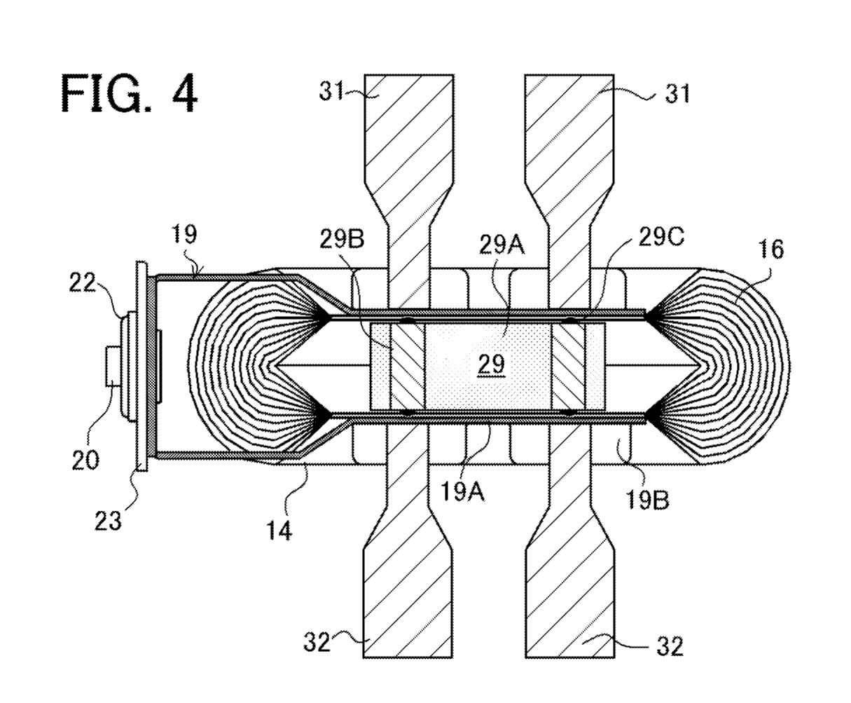

Firstly, as an example of a secondary battery of the embodiment with a flat wound electrode assembly that is common among the embodiment and comparative examples, a prismatic nonaqueous electrolyte secondary battery will be described with reference to FIG. 1 to FIG. 4. FIG. 1 is a partial development view illustrating the arrangement relation between electrode plates and a separator of a wound electrode assembly of a prismatic nonaqueous electrolyte secondary battery that is under producing. FIG. 2A is a sectional view of the prismatic nonaqueous electrolyte secondary battery. FIG. 2B is a sectional view taken along IIB-IIB line of FIG. 2A. FIG. 2C is a sectional view taken along IIC-IIC line of FIG. 2A. FIG. 3A is a perspective view of a flat wound electrode assembly according to an embodiment. FIG. 3B is a perspective view of the backside of the flat wound electrode assembly of FIG. 3A. FIG. 3C is a sectional view taken along IIIC-IIIC line of FIG. 3A. FIG. 4 is a lateral sectional view illustrating a state of resistance welding between a negative electrode substrate exposed portion and a collector.

This prismatic nonaqueous electrolyte secondary battery 10 includes a flat wound electrode assembly 14 in which a positive electrode plate 11 and a negative electrode plate 12 are wound with a separator 13 interposed therebetween. The positive electrode plate 11 is prepared by coating both faces of a positive electrode substrate made of aluminum foil with a positive electrode active material mixture slurry, then drying and rolling the coated substrate, and slitting the substrate so as to expose the aluminum foil in a strip shape. The negative electrode plate 12 is prepared by coating both faces of a negative electrode substrate made of copper foil with a negative electrode active material mixture slurry, then drying and rolling the coated substrate, and slitting the substrate so as to expose the copper foil in a strip shape.

Then, the positive electrode plate 11 and the negative electrode plate 12 obtained as mentioned above are stacked with the microporous polyolefin separator 13 interposed therebetween so as to displace the aluminum foil exposed portion of the positive electrode plate 11 and the copper foil exposed portion of the negative electrode plate 12 from the counter electrode active material mixture layers 12a and 11a, respectively. Subsequently, the whole is wound to prepare the flat wound electrode assembly 14 including a plurality of stacked positive electrode substrate exposed portions 15 on one end in the winding axis direction and including a plurality of stacked negative electrode substrate exposed portions 16 on the other end.

The plurality of stacked positive electrode substrate exposed portions 15 are connected to a positive electrode terminal 18 with a positive electrode collector 17 interposed therebetween, and similarly, the plurality of stacked negative electrode substrate exposed portions 16 are connected to a negative electrode terminal 20 with a negative electrode collector 19 interposed therebetween. In the exemplified case, the positive electrode collector 17 and the negative electrode collector 19 are directly connected to the positive electrode terminal 18 and the negative electrode terminal 20, respectively. The positive electrode collector 17 and the negative electrode collector 19 may be, however, connected to the positive electrode terminal 18 and the negative electrode terminal 20 with respective additional conductive members such as a current breaker interposed therebetween.

The positive electrode terminal 18 and the negative electrode terminal 20 are fixed to a sealing plate 23 with insulating members 21 and 22 interposed therebetween, respectively. The prismatic nonaqueous electrolyte secondary battery 10 that is common among the embodiment and the comparative examples is produced by inserting the flat wound electrode assembly 14 prepared as mentioned above into a prismatic outer body 25 with a resin insulating plate 24 provided therebetween except the sealing plate 23 side, then laser-welding the sealing plate 23 to the mouth portion of the outer body 25, then pouring a nonaqueous electrolytic solution from an electrolyte pour hole 26, and sealing up the electrolyte pour hole 26. The sealing plate 23 includes a gas exhaust valve 27 as a safety measure.

In the positive electrode plate 11 side in the flat wound electrode assembly 14, the plurality of wound-and-stacked positive electrode substrate exposed portions 15 are converged on the central site in the thickness direction and divided into two portions, and a positive electrode intermediate member 28 is disposed between the two portions (see FIG. 2B). The positive electrode intermediate member 28 includes an insulating intermediate member 28A made of a resin material and a plurality of conductive intermediate members 28B, two conductive intermediate members 28B in the embodiment, supported by the insulating intermediate member 28A. Each of the conductive intermediate members 28B includes a protrusion 28C in a truncated cone shape functioning as a projection on each side facing the stacked positive electrode substrate exposed portion 15.

In a similar manner, the plurality of wound-and-stacked negative electrode substrate exposed portions 16 are converged on the central site in the thickness direction and divided into two portions at the negative electrode plate 12 side, and a negative electrode intermediate member 29 is disposed between the two portions (see FIG. 2B and FIG. 2C). The negative electrode intermediate member 29 includes an insulating intermediate member 29A made of a resin material and a plurality of conductive intermediate members 29B, two conductive intermediate members 29B in the embodiment, supported by the insulating intermediate member 29A. Each of the conductive intermediate members 29B includes a protrusion 29C in a truncated cone shape functioning as a projection on each side facing the stacked negative electrode substrate exposed portion 16.

The positive electrode collector 17 is disposed on the outermost surface of the positive electrode substrate exposed portion 15 positioned on each side of the positive electrode intermediate member 28. The negative electrode collector 19 is disposed on the outermost surface of the negative electrode substrate exposed portion 16 positioned on each side of the negative electrode intermediate member 29.

The conductive intermediate member 28B constituting the positive electrode intermediate member 28 is made of aluminum, which is the same material as that of the positive electrode substrate. The conductive intermediate member 29B constituting the negative electrode intermediate member 29 is made of copper, which is the same material as that of the negative electrode substrate. The shape of the conductive intermediate member 28B may be the same as or different from that of the conductive intermediate member 29B. Examples of the material usable as the insulating intermediate member 28A constituting the positive electrode intermediate member 28 and as the insulating intermediate member 29A constituting the negative electrode intermediate member 29 include polypropylene (PP), polyethylene (PE), polyvinylidene chloride (PVDC), polyacetal (POM), polyamide (PA), polycarbonate (PC), and polyphenylene sulfide (PPS).

In the prismatic nonaqueous electrolyte secondary battery 10 that is common among the embodiment and the comparative examples, the exemplified positive electrode intermediate member 28 and the exemplified negative electrode intermediate member 29 include insulating intermediate members 28A and 29A made of a resin material and having two conductive intermediate members 28B and 29B, respectively, but the insulating intermediate members 28A and 29A are not always necessary. One or three or more conductive intermediate members 28B and 29B may be used depending on a required battery output power and similar factors. When two or more of the conductive intermediate members 28B and 29B are used, both the insulating intermediate members 28A and 29A made of a resin material hold two or more conductive intermediate members 28B or 29B. Each pair of the conductive intermediate members 28B and 29B can be therefore stably positioned and disposed between the bisectional substrate exposed portions.

The positive electrode collector 17 is resistance-welded to the outermost surface of the bisectional positive electrode substrate exposed portion 15, the positive electrode substrate exposed portions 15 are resistance-welded to each other, and the conductive intermediate member 28B of the positive electrode intermediate member 28 is resistance-welded to the inner surface of the bisectional positive electrode substrate exposed portion 15. Similarly, the negative electrode collector 19 is resistance-welded to the outermost surface of the bisectional negative electrode substrate exposed portion 16, the negative electrode substrate exposed portions 16 are resistance-welded to each other, and the conductive intermediate member 29B constituting the negative electrode intermediate member 29 is resistance-welded to the inner surface of the bisectional negative electrode substrate exposed portion 16.

The following will now be described in detail with reference to FIG. 2 and FIG. 3: a specific method for producing the flat wound electrode assembly 14, the resistance welding method using the positive electrode substrate exposed portion 15, the positive electrode collector 17, and the positive electrode intermediate member 28 having the conductive intermediate member 28B, and the resistance welding method using the negative electrode substrate exposed portion 16, the negative electrode collector 19, and the negative electrode intermediate member 29 having the conductive intermediate member 29B. In the embodiment, the shape of the positive electrode intermediate member 28 may be substantially the same as the shape of the negative electrode intermediate member 29, and both resistance welding methods are substantially the same. The method for the negative electrode plate 12 side will be therefore described below as a typical example.

First, as shown in FIG. 1, the positive electrode plate 11 and the negative electrode plate 12 were stacked with the microporous polyolefin separator 13 interposed therebetween so as to displace the positive electrode substrate (aluminum foil) exposed portion 15 of the positive electrode plate 11 and the negative electrode substrate (copper foil) exposed portion 16 of the negative electrode plate 12 from the counter electrode active material mixtures 12a and 11a, respectively, and the whole was wound cylindrically, after which the cylindrical wound electrode assembly was subjected to press molding to prepare the flat wound electrode assembly 14 that is common among the embodiment and the comparative examples.

In the flat wound electrode assembly 14 of the embodiment, as shown in FIG. 3A to FIG. 3C, a semi-floating prevention tape 35 made from polypropylene (PP) is wound around the flat wound electrode assembly 14 at the boundary region between a separator 13 located in the outermost surface side and the negative electrode substrate exposed portion 16 so that exposed width in the negative electrode substrate exposed portion 16 side becomes 5 mm. The semi-floating prevention tape 35 corresponds to a “fixing member” in the invention. The flat wound electrode assembly of one of the comparative examples has the same configuration with that of the flat wound electrode assembly 14 of the embodiment except that the configuration mentioned above has no semi-floating prevention tape.

Then, in the flat wound electrode assembly 14 of the embodiment and the comparative examples, the negative electrode substrate exposed portion 16 was divided from the wound center to both sides into two portions, and the bisectional negative electrode substrate exposed portion 16 was converged on the center, which is a quarter of the thickness of the electrode assembly. The negative electrode collector 19 was prepared by punching out and bending a copper plate having a thickness of 0.6 mm, etc. The negative electrode collector 19 may be prepared by, for example, casting of a copper plate. The negative electrode collector 19 used here includes a main body 19A extending from a resistance-welding position to the negative electrode terminal 20 and a rib 19B extending from the welding position of the main body 19A in an approximately perpendicular direction and is integrally formed so as to have a symmetric structure with respect to the negative electrode terminal 20.

Then, the negative electrode collector 19 is disposed on each outermost surface of the bisectional negative electrode substrate exposed portion 16. The negative electrode intermediate member 29 is inserted between the inner surfaces of the bisectional negative electrode substrate exposed portion 16 so as to bring the truncated-cone-shaped protrusions 29C on both sides of the conductive intermediate member 29B into contact with the respective inner surfaces of the bisectional negative electrode substrate exposed portion 16. The conductive intermediate member 29B of the negative electrode intermediate member 29 has, for example, a column shape and includes both ends with the truncated-cone-shaped protrusions 29C. An opening may be formed in each truncated-cone-shaped protrusion 29C in order to concentrate current onto the periphery of the truncated-cone-shaped protrusion 29C during resistance welding, thereby forming a fine weld mark (nugget). The truncated-cone-shaped protrusion 29C may have substantially the same height as that of a protrusion (projection) generally formed on a resistance welding member, in other words, may have a height of several millimeters.

The diameter and the length of the conductive intermediate member 29B constituting the negative electrode intermediate member 29 vary depending on the sizes of the flat wound electrode assembly 14 and the outer body 25 (see FIG. 2 and FIG. 3) and may be about 3 mm to several tens of millimeters. The conductive intermediate member 29B constituting the negative electrode intermediate member 29 has been exemplified to have a column shape in the embodiment, but may have any shape, for example, a prismatic shape and an elliptical column shape, as long as it is a metal block.

In the negative electrode intermediate member 29, each of the two conductive intermediate members 29B is integrally held with the insulating intermediate member 29A made of a resin material. In this case, the conductive intermediate members 29B are held so as to be parallel to each other and are disposed so that each end face of the conductive intermediate member 29B, that is, each face with the truncated-cone-shaped protrusion 29C, is opposite to the inner surface of the bisectional negative electrode substrate exposed portion 16. The insulating intermediate member 29A made of a resin material constituting the negative electrode intermediate member 29 may have any shape, for example, a prismatic shape and a column shape. In the embodiment, however, the shape is a prismatic shape for stable positioning and fixing between the bisectional negative electrode substrate exposed portions 16.

The length of the negative electrode intermediate member 29 varies depending on the size of the prismatic nonaqueous electrolyte secondary battery but may be 20 mm to several tens of millimeters. The width is preferably designed so that, around the negative electrode intermediate member 29, the side faces of the insulating intermediate member 29A made of a resin material may be in contact with the inner surface of the bisectional negative electrode substrate exposed portion 16 after resistance welding. In other regions, for example, a groove may be formed on a peripheral part of the negative electrode intermediate member 29 or a cavity may be formed inside the negative electrode intermediate member 29 for good degassing during resistance welding.

Next, as shown in FIG. 4, the flat wound electrode assembly 14 is disposed between a pair of resistance welding electrodes 31 and 32 disposed above and below. Additionally, the negative electrode collector 19 is disposed so that each main body 19A at a position of the rib 19B faces the truncated-cone-shaped protrusion 29C formed on each side of the conductive intermediate member 29B across the bisectional negative electrode substrate exposed portion 16. The pair of resistance welding electrodes 31 and 32 are brought into contact with the main body 19A of the negative electrode collector 19.

The negative electrode collector 19 may be disposed on each outermost surface of the negative electrode substrate exposed portion 16 before or after disposing the negative electrode intermediate member 29 between the bisectional negative electrode substrate exposed portions 16. The negative electrode collector 19 may be connected to the negative electrode terminal 20 before or after resistance-welding the negative electrode collector 19 to the negative electrode substrate exposed portion 16. Connection of the negative electrode collector 19 to the negative electrode terminal 20 followed by resistance welding of the negative electrode collector 19 to the negative electrode substrate exposed portion 16, however, leads to easy positioning during resistance welding to improve production efficiency.

Then, an appropriate pressure is applied between the pair of resistance welding electrodes 31 and 32 so as to apply pressure to the negative electrode collector 19 equally, followed by resistance welding in a predetermined condition. A resistance-welding current flows, for example, in the following order: the resistance welding electrode 31, the upper main body 19A of the negative electrode collector 19, the bisectional negative electrode substrate exposed portion 16, the conductive intermediate member 29B, the bisectional negative electrode substrate exposed portion 16, the lower main body 19A of the negative electrode collector 19, to the resistance welding electrode 32. This forms the resistance-welded parts between the upper main body 19A of the negative electrode collector 19, the bisectional negative electrode substrate exposed portion 16, and one end face of the conductive intermediate member 29B and between the other end face of the conductive intermediate member 29B, the bisectional negative electrode substrate exposed portion 16, and the lower main body 19A of the negative electrode collector 19.

At this time, the negative electrode collector 19 having a symmetric structure with respect to the negative electrode terminal 20 is short-circuited from the upper main body 19A to the lower main body 19A, and reactive current flows. Flowing a large resistance-welding current can, however, achieve effective resistance welding by maintaining an appropriate pressure between the pair of resistance welding electrode rods 31 and 32. Furthermore, the negative electrode intermediate member 29 is disposed between the bisectional negative electrode substrate exposed portions 16 while being stably positioned during the resistance welding. This enables resistance welding in an exact and stable condition, and can suppress variation in the welding strength, thereby achieving low resistivity of the welded part. A prismatic nonaqueous electrolyte secondary battery capable of high-current charging and discharging can be produced in this manner.

The exemplified conductive intermediate member 29B constituting the negative electrode intermediate member 29 includes both ends on which the truncated-cone-shaped protrusions 29C are formed. The truncated-cone-shaped protrusion 29C is not, however, a necessary component and can be omitted. In the exemplified embodiment, the protrusion may have a truncated triangular pyramid shape, a truncated square pyramid shape, and a truncated multiangular pyramid shape instead of the truncated-cone-shaped protrusion 29C.

In this manner, the wound electrode assembly 14 to be used in the prismatic nonaqueous electrolyte secondary battery 10 of the embodiment and the comparative examples can be prepared. The wound electrode assembly 14 includes the wound-and-stacked positive electrode substrate exposed portion 15 on one end in the winding axis direction and includes the wound-and-stacked negative electrode substrate exposed portion 16 on the other end in the winding axis direction. The positive electrode collector 17 is connected to the outermost surface of the stacked positive electrode substrate exposed portion 15 in the stacking direction by welding, and the negative electrode collector 19 is connected to the outermost surface of the stacked negative electrode substrate exposed portion 16 in the stacking direction by welding.

In the prismatic nonaqueous electrolyte secondary battery 10 illustrated in FIG. 2A and FIG. 2B, in the positive electrode plate 11 side similarly to the case of the negative electrode plate 12 side, a positive electrode intermediate member 28 including an insulating intermediate member 28A, a conductive intermediate member 28B, and a truncated-cone-shaped protrusion 28C is disposed on the inner side of the bisectional positive electrode substrate exposed portion 15, and a positive electrode collector 17 including main bodies 17A and ribs 17B is disposed on the outermost surfaces of the positive electrode substrate exposed portion 15, followed by resistance welding, as an example. The positive electrode intermediate member 28 and the negative electrode intermediate member 29 are not, however, necessary components, and may be provided on one of the positive electrode substrate exposed portion 15 and the negative electrode substrate exposed portion 16. Furthermore, without the positive electrode intermediate member 28 or the negative electrode intermediate member 29, in other words, without dividing the positive electrode substrate exposed portion 15 or the negative electrode substrate exposed portion 16 into two portions, the positive electrode collector 17 and the negative electrode collector 19 may be attached to the respective electrode substrate exposed portions by resistance welding.

The ribs 17B and 19B formed on the positive electrode collector 17 and the negative electrode collector 19, respectively, were integrally formed with respective main bodies 17A and 19A. The ribs 17B and 19B were formed by folding parts of the positive electrode collector 17 and the negative electrode collector 19 substantially orthogonally at the boundary portion between the main bodies 17A and 19A.

In this way, ten nonaqueous electrolyte secondary batteries were produced for each of the embodiment and the comparative examples. Then, it was visually checked whether phenomenon of semi-floating of the negative electrode active material mixture layer has occurred. Table 1 shows the results. In the table, “Poor” means at least one semi-floating was found and “Good” means no semi-floating was found.

TABLE 1

| | | Stacked | Thickness of | Thickness of | |
|---|---|---|---|---|---|
| | Fixed | layers | positive | negative | |
| | with | (positive | electrode | electrode | Confirmed |
| | tape | electrode) | (μm) | (μm) | result |
| Comparative | No | 66 | 152 | 126 | Poor |
| examples | | | | | |
| Embodiment | Yes | 66 | 152 | 126 | Good |

The results in Table 1 show that the battery of the embodiment does not cause semi-floating of the negative electrode active material mixture layer substantially, thus peeling off of the negative electrode active material mixture layers is prevented during the production of the batteries, and introducing conductive foreign materials into batteries is suppressed, thereby obtaining secondary batteries having higher reliability.

### Modification Examples 1 and 2

The embodiment described above has been exemplified using the negative electrode collector 19 coming into contact with both faces of the outermost surface of the bisectional negative electrode substrate exposed portion 16. It is not always necessary, however, that the negative electrode collector 19 connected to the negative electrode terminal 20 is in contact with both faces of the outermost surface of the bisectional negative electrode substrate exposed portion 16. The negative electrode collector 19 may be in contact with at least one of the faces of the outermost surface of the bisectional negative electrode substrate exposed portion 16.

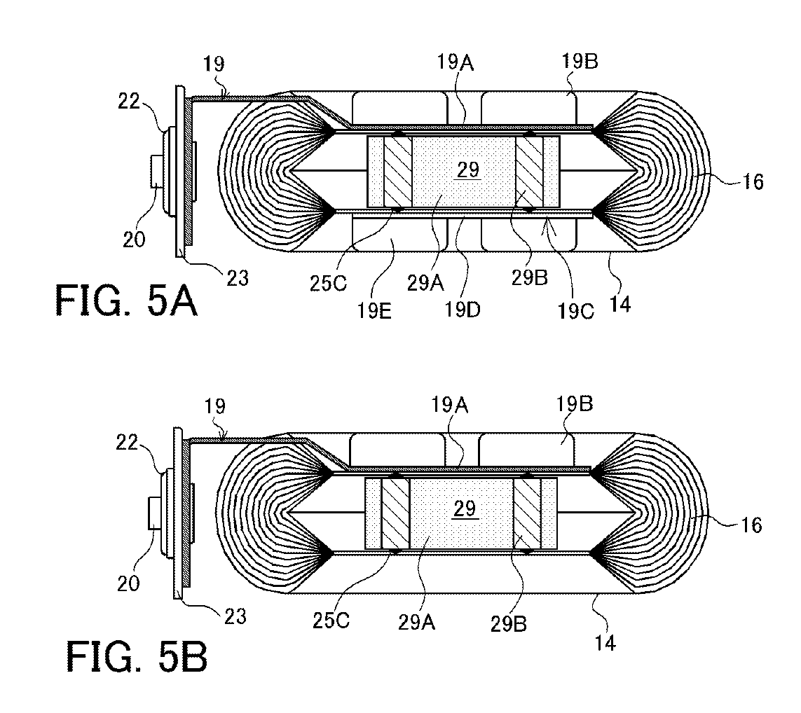

The arrangement status of the negative electrode collectors 19 after resistance welding of Modification Examples 1 and 2 in which each negative electrode collector 19 connected to the negative electrode terminal 20 is in contact with one of the faces of the outermost surface of the bisectional negative electrode substrate exposed portion 16 will be described with reference to FIG. 5A and FIG. 5B. FIG. 5A is a sectional view taken along IIC-IIC line of FIG. 2A corresponding to Modification Example 1. FIG. 5B is a sectional view taken along IIC-IIC line of FIG. 2A corresponding to Modification Example 2. It should be noted that the configurations of the flat wound electrode assembly 14 and the negative electrode intermediate member 29 in Modification Examples 1 and 2 are the same as that of the embodiment. The same components as those shown in the embodiment are shown by the same reference characters and are not described in detail.

In Modification Example 1, as shown in FIG. 5A, the main body 19A of the negative electrode collector 19 connected to the negative electrode terminal 20 is disposed on one of the faces of the outermost surface of the bisectional negative electrode substrate exposed portion 16 so as to bring the main body 19A into contact therewith, a negative electrode collector supporting member 19C is disposed on the other face of the outermost surface of bisectional negative electrode substrate exposed portion 16 so as to bring the negative electrode collector supporting member 19C into contact therewith, and the negative electrode collector 19 and the negative electrode collector supporting member 19C are resistance-welded together with a pair of resistance welding electrodes coming into contact therewith. In the case of Modification Example 1, the negative electrode supporting member 19C is not directly electrically connected to the negative electrode terminal 20 but is directly connected only to the negative electrode substrate exposed portion 16. The negative electrode supporting member 19C serves as a receptor supporting one of the sides of a pair of resistance-welding electrodes during resistance welding. The negative electrode collector supporting member 19C in Modification Example 1 includes a main body 19D and a rib 19E formed by folding. Thereby, Modification Example 1 substantially has the same effects with the above embodiment.

That is, the negative electrode supporting member 19C has substantially the same effects as those of the negative electrode collector 19 except that the negative electrode supporting member 19C is not connected to the negative electrode terminal 20. The word “collector” in the invention is therefore used to mean the “collector supporting member”. When the negative electrode collector member is disposed on each side of the outermost surface of the bisectional negative electrode substrate exposed portion like in the embodiment rather than using the negative electrode supporting member 19C, resistance-welding can be performed in a physically stable condition.

In Modification Example 2, as shown in FIG. 5B, the negative electrode collector 19 is disposed on one of the faces of the outermost surface of the bisectional negative electrode substrate exposed portion 16 so as to bring the negative electrode collector 19 into contact therewith, nothing is disposed on the other face of the outermost surface of bisectional positive electrode substrate exposed portion 14, and the negative electrode collector 19 and the other face of the outermost surface of bisectional negative electrode substrate exposed portion 16 are resistance-welded together with a pair of resistance welding electrodes so as to come into contact therewith. That is, in Modification Example 2, one of the sides of a pair of resistance welding electrodes directly comes into contact with the other face of the outermost surface of the bisectional negative electrode substrate exposed portion 16 to be resistance-welded thereto. The configuration of Modification Example 2 can achieve passable resistance-welding; however, fusion between the resistance welding electrodes and the other face of the outermost surface of the bisectional negative electrode substrate exposed portion 16 may occur. Accordingly, it is preferable that the negative electrode collector 19 or the negative electrode collector supporting member 19C be disposed on the other face of the outermost surface of the bisectional negative electrode substrate exposed portion 16 like in the embodiment and Modification example 1.

### Modification Examples 3 and 4

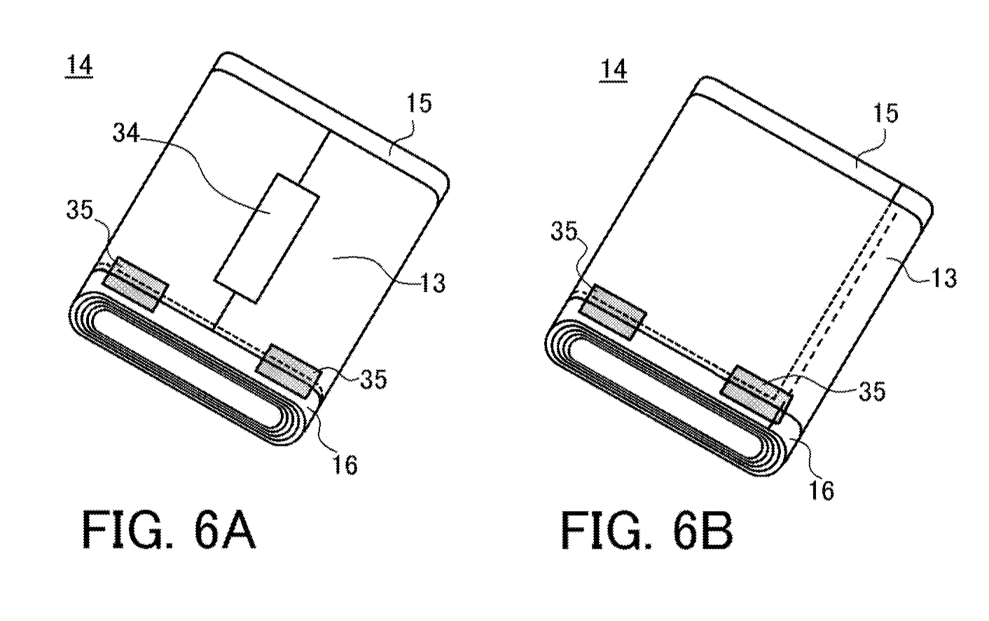

In the exemplified flat wound electrode assembly 14, as shown in FIG. 3A to FIG. 3C, the semi-floating prevention tape 35 is wound around the flat wound electrode assembly 14 at the boundary region between the separator 13 located in the outermost surface side and the negative electrode substrate exposed portion 16. In the flat wound electrode assembly, however, semi-floating and peeling of the negative electrode active material mixture layer at the outermost surface of the negative electrode plate tend to happen near corners. As Modification Example 3 shown in FIG. 6A and FIG. 6B, putting the semi-floating prevention tape 35 on each of four corners also provides excellent effects. FIG. 6A is a perspective view of a flat wound electrode assembly of Modification Example 3. FIG. 6B is a perspective view of the backside of the flat wound electrode assembly of FIG. 6A.

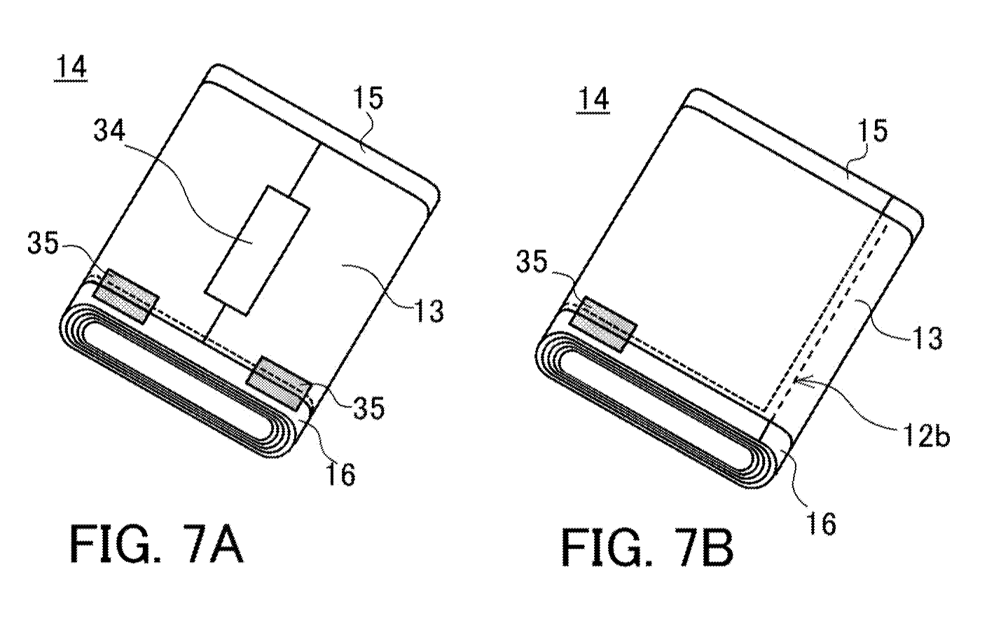

In the flat wound electrode assembly, when an end-of-winding portion 12b of the outermost surface of the negative electrode plate is located near a corner, the edge portion of the end-of-winding portion 12b is not a curved portion on the outer surface of the flat wound electrode assembly 14, and stress is hardly applied to the end-of-winding portion 12b side. Accordingly, semi-floating of the negative electrode active material mixture layer rarely occurs. In this case, as Modification Example 4 shown in FIG. 7A and FIG. 7B, putting the semi-floating prevention tape 35 on each three corners except the corner in which the end-of-winding portion 12b is located also provides excellent positive effects. FIG. 7A is a perspective view of a flat wound electrode assembly of Modification Example 4. FIG. 7B is a perspective view of the backside of the flat wound electrode assembly of FIG. 7A.

What is claimed is:

1. A secondary battery comprising:
a flat wound electrode assembly including a positive electrode plate with a positive electrode substrate having positive electrode active material mixture layers on both faces and with a positive electrode substrate exposed portion along the longitudinal direction, a negative electrode plate with a negative electrode substrate having negative electrode active material mixture layers on both faces and with a negative electrode substrate exposed portion along the longitudinal direction, and a separator interposed therebetween, the positive electrode plate, the negative electrode plate, and the separator being wound together,
the flat wound electrode assembly including the wound positive electrode substrate exposed portion formed on one end portion thereof and the wound negative electrode substrate exposed portion formed on another end portion thereof,
an end portion of a negative electrode active material mixture layer of the negative electrode plate on the negative electrode substrate exposed portion side protruding more than an end portion of a positive electrode active material mixture layer of the adjacent positive electrode plate,
the negative electrode substrate exposed portion being converged on a central site in the thickness direction of the flat wound electrode assembly,
the separator being located at the outermost surface of the flat wound electrode assembly, and
the separator located at the outermost surface and the negative electrode substrate exposed portion of the adjacent negative electrode plate being fixed integrally with a fixing member.

2. The secondary battery according to claim 1, wherein the negative electrode substrate exposed portion is equally converged on the central site in the thickness direction of the flat wound electrode assembly.

3. The secondary battery according to claim 1, wherein the fixing member is provided to each of both faces of the flat wound electrode assembly.

4. The secondary battery according to claim 2, wherein the fixing member is provided to each of both faces of the flat wound electrode assembly.

5. The secondary battery according to claim 1, wherein a collector member is provided to each of both outermost surfaces of the negative electrode substrate exposed portion.

6. The secondary battery according to claim 1, wherein a converged section of the negative electrode substrate exposed portion is divided into two portions, and a conductive intermediate member is disposed between the two portions of the converged section.

7. The secondary battery according to claim 6, wherein a plurality of such conductive intermediate members are supported by an insulating intermediate member.

8. The secondary battery according to claim 1, wherein an end-of-winding portion of the negative electrode plate is located near a corner of the flat wound electrode assembly, and the fixing member is disposed near three corners of the flat wound electrode assembly except the corner in which the end-of-winding portion is located.
